(19) United States
(12) Patent Application Publication
(10) Pub. No.: US 2015/0151623 A1
(43) Pub. Date: Jun. 4, 2015

(54) Vehicle Sun Shelter

(71) Applicants: Lion Li, San Gabriel, CA (US); Sun Wei Li, San Gabriel, CA (US)

(72) Inventors: Lion Li, San Gabriel, CA (US); Sun Wei Li, San Gabriel, CA (US)

(21) Appl. No.: 14/095,967

(22) Filed: Dec. 3, 2013

(51) Int. Cl. B60J 11/08

(52) U.S. Cl. CPC B60J 11/08

(57) ABSTRACT

A vehicle sun shelter for a vehicle includes an exterior shelter for shading an exterior of the vehicle to block heat radiation of sunlight entering into the vehicle and a quick releasable fastener for releasably fastening a vehicle body of the vehicle in order to retain the exterior shelter in position. The exterior shelter includes a front shelter adapted for shading a front windshield of the vehicle, a rear shelter adapted for shading a rear windshield of the vehicle, and a flexible shade which includes two side shading sheets extended between the front and rear shelters for shading side windows of the vehicle respectively. Therefore, the window frame of the vehicle is completely shield by the exterior shelter to effectively prevent the heat entering into the vehicle.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a shading device, and more particular to a vehicle sun shelter adapted for quickly mounting to a vehicle to cover a window frame thereof so as to block heat radiation of sunlight entering into the vehicle through the window frame.

2. Description of Related Arts

When a vehicle is parked under the sun that the vehicle is exposed to the sun for a period of time, the sunlight will directly enter into the vehicle through the windows. As a result, the interior of the vehicle becomes hotter that the interior temperature will higher than an ambient temperature outside the vehicle. People, such as the driver and passenger, will feel uncomfortable when they must enter the vehicle. In some instances, the heat trapped in the vehicle will melt any plastic component or crack the leather seat in the vehicle, and even burn the skin of a person when he or she touches any hot component in the vehicle.

One way to block the heat entering into the vehicle is that the driver can tint the windows of the vehicle to minimize the sunlight directly entering into the vehicle. However, the tinted windows, especially the front windshield and front side windows, of the vehicle are prohibited in many countries.

Using a window shading device, such as a light reflective panel, is considered as an effective way to block the sunlight directly entering into the vehicle. The driver is able to place the window shading device at the interior of the vehicle to overlap on the inner side of the front windshield. However, sunlight will still enter into the vehicle through other windows unless multiple window shading devices are used to place at the inner sides of all other windows. In other words, the driver must put on and take off the window shading devices every time when he or she parks the vehicle and gets back to the vehicle. In fact, the window shading device cannot totally block the sunlight entering into the vehicle because the size and shape of the window shading device does not perfectly match with the size and shape of each window of the vehicle.

Another shading device is a vehicle umbrella device that mounts to an exterior of the vehicle. Such vehicle umbrella device generally comprises a roof mount mounted on top of the roof of the vehicle and an awning frame extended from the roof mount for shading the exterior of the vehicle. Accordingly, the roof mount is detachably mounted on the roof of the vehicle by means of magnetic engagement. In other words, the roof mount can only mounted to the metal roof. Therefore, the vehicle umbrella device cannot be used for the vehicle having a “moon roof” or “panorama roof” which is not made of metal. In addition, the weight of the vehicle umbrella device, including the roof mount and the awning frame, will directly apply to the roof of the vehicle to damage the roof thereof. Thus, the mounting area between the vehicle umbrella device and the roof of the vehicle is relatively small that wind will blow the vehicle umbrella device away from the vehicle. The covering area of the awning frame may not match with the size of the vehicle, such that some windows may uncovered by the awning frame. More importantly, the awning frame must be big enough to cover the exterior of the vehicle. In other words, the awning frame cannot be folded into a compact unit for storage.

### SUMMARY OF THE PRESENT INVENTION

The invention is advantageous in that it provides a vehicle sun shelter, which adapted for quickly mounting to a vehicle to cover a window frame thereof so as to block heat radiation of sunlight entering into the vehicle through the window frame.

Another advantage of the invention is to provide a vehicle sun shelter, wherein the front and rear shelters form a planar structure to shade the front and rear windshields respectively so as to effectively block the heat radiation of sunlight entering into the vehicle through the front and rear windshields.

Another advantage of the invention is to provide a vehicle sun shelter, wherein two side shading sheets are extended between the front and rear shelters to shade the side windows of the vehicle respectively so as to effectively block the heat radiation of sunlight entering into the vehicle through the side windows.

Another advantage of the invention is to provide a vehicle sun shelter, wherein two side shading sheets are automatically aligned to shade at the side windows of the vehicle when the front and rear shelters are placed at the front and rear windshields respectively, so as to simplify the shading operation of the vehicle sun shelter to shade the window frame of the vehicle.

Another advantage of the invention is to provide a vehicle sun shelter, wherein the top shading sheet are extended between the front and rear shelters for shading a roof of the vehicle so as to effectively block the heat radiation of sunlight entering into the vehicle through the roof.

Another advantage of the invention is to provide a vehicle sun shelter, which can be quickly and easily folded into a compact size for storage.

Another advantage of the invention is to provide a vehicle sun shelter, wherein when the exterior shelter covers the window frame of the vehicle, the interior of the vehicle cannot be seen through the exterior shelter so as to completely conceal the interior of the vehicle for protecting privacy.

Another advantage of the invention is to provide a vehicle sun shelter, which provides an air mesh for enabling an air circulation between an interior of the exterior shelter and an exterior thereof, so as to prevent hot air and/or wind being trapped within the exterior shelter.

Another advantage of the invention is to provide a vehicle sun shelter, wherein the quick releasable fastener is adapted to detachably, quickly and easily fasten with the vehicle body to provide multiple fastening points for retaining the exterior shelter in position.

Another advantage of the invention is to provide a vehicle sun shelter, wherein the quick releasable fastener provides different types of fasteners to selectively fasten at the side mirror frames, door handles and trunk so as to secure the exterior shelter to cover the window frame of the vehicle.

Another advantage of the invention is to provide a vehicle sun shelter, wherein no external force is directly applied onto the roof of the vehicle when the exterior shelter is mounted to the vehicle so as to prevent any damage of the vehicle.

Another advantage of the invention is to provide a vehicle sun shelter, which also provides an advertising function when the vehicle is shielded by the vehicle sun shelter.

Another advantage of the invention is to provide a vehicle sun shelter, which does not require to alter the original structural design of the vehicle, so as to provide a universal sun shelter to incorporate with any vehicle.

Another advantage of the invention is to provide a vehicle sun shelter, wherein no expensive or complicated structure is required to employ in the present invention in order to achieve the above mentioned objects. Therefore, the present invention successfully provides an economic and efficient solution for blocking heat radiation of sunlight entering into the vehicle through the window frame thereof.

Additional advantages and features of the invention will become apparent from the description which follows, and may be realized by means of the instrumentalities and combinations particular point out in the appended claims.

According to the present invention, the foregoing and other objects and advantages are attained by a sun shelter which comprises an exterior shelter for shading an exterior of the vehicle to block heat radiation of sunlight entering into the vehicle, and a quick releasable fastener for retaining the exterior shelter in position.

The exterior shelter comprises a front shelter adapted for shading a front windshield of the vehicle, a rear shelter adapted for shading a rear windshield of the vehicle, and a flexible shade which comprises two side shading sheets extended between the front and rear shelters for shading side windows of the vehicle respectively.

The quick releasable fastener is extended from the exterior shelter for releasably fastening a vehicle body of the vehicle below the side windows thereof, such that at least two fastening points is provided for the exterior shelter to retain the exterior shelter in position.

In accordance with another aspect of the invention, the present invention comprises a method of blocking heat radiation of sunlight entering into the vehicle, comprising the following steps.

(A) Place a front shelter at a front windshield of the vehicle and a rear shelter at a rear windshield of the vehicle for blocking heat radiation entering into the vehicle through the front and rear windshields.

(B) Automatically align two side shading sheets, which are extended between the front and rear shelters, with side windows of the vehicle respectively at the time when the front and rear shelters are placed in position for blocking heat radiation entering into the vehicle through the side windows.

(C) Detachably fasten a quick releasable fastener to a vehicle body of the vehicle below the side windows thereof to provide at least two fastening points to retain the front and rear shelters and the side shading sheets in position.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a vehicle sun shelter for a vehicle according to a preferred embodiment of the present invention.

FIG. 2 is a side view of the vehicle sun shelter according to the above preferred embodiment of the present invention, illustrating the window frame of the vehicle being shaded by the vehicle sun shelter.

FIG. 3 is a partially front perspective view of the vehicle sun shelter according to the above preferred embodiment of the present invention.

FIG. 4 is a partially rear perspective view of the vehicle sun shelter according to the above preferred embodiment of the present invention.

FIG. 5 illustrates a folding operation of the vehicle sun shelter according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

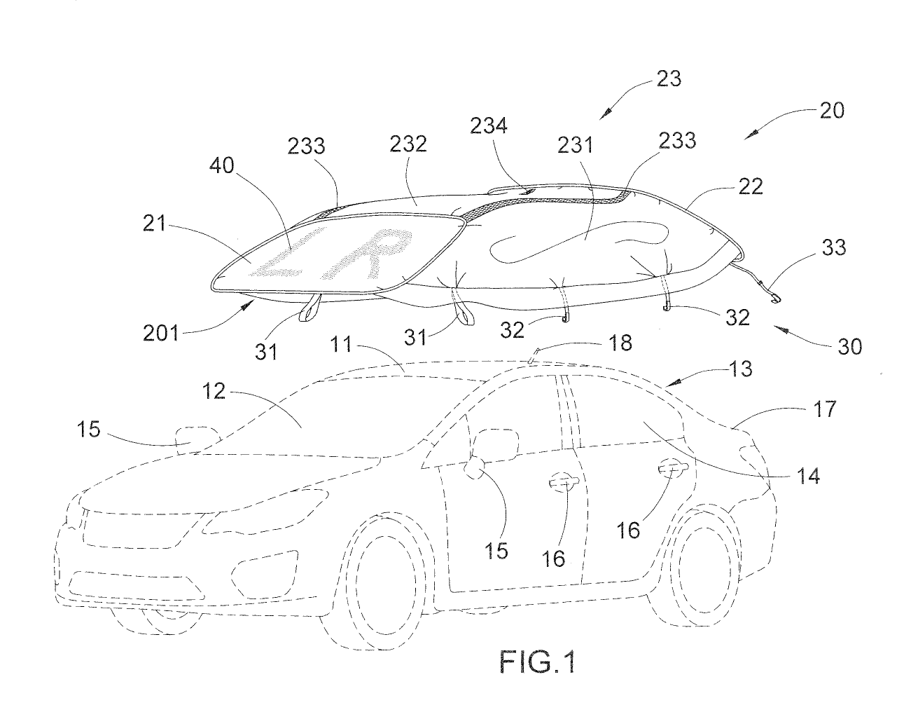

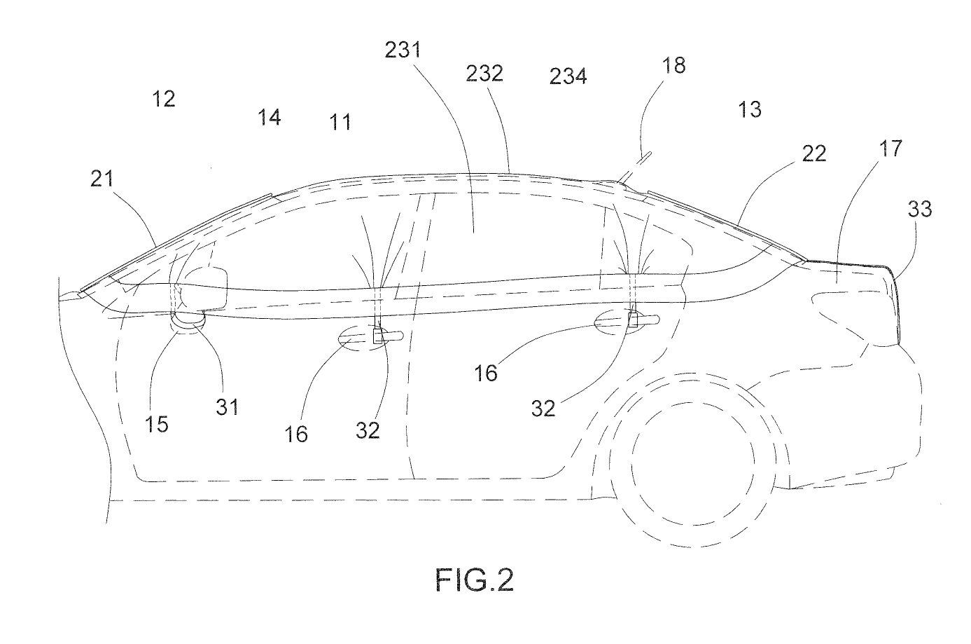

Referring to FIGS. 1 and 2 of the drawings, a vehicle sun shelter for a vehicle according to a preferred embodiment is illustrated, wherein the vehicle sun shelter is adapted for blocking heat of sunlight entering into the vehicle. Accordingly, the vehicle generally comprises an upper vehicle frame and a lower vehicle body. The upper vehicle frame comprises a roof 11 and a window frame which comprises a front windshield 12, a rear windshield 13, and two side windows 14. The vehicle body is defined as a portion of the vehicle below the window frame. It is worth mentioning that when the vehicle is parked under the sun, the heat radiation of the sunlight will directly enter into the interior of the vehicle through the upper vehicle frame, i.e. the roof 11 and the window frame. In other words, the interior temperature of the vehicle is mainly changed in response to the heat radiation at the upper vehicle frame but not at the vehicle body.

The vehicle sun shelter of the present invention comprises an exterior shelter 20 for shading an exterior of the vehicle to block heat radiation of sunlight entering into the vehicle. In particular, the exterior shelter 20, having a sheltering cavity 201, is arranged for shading the upper vehicle frame of the vehicle only to prevent the head radiation directly entering into the vehicle through the roof and the window frame of the vehicle.

As shown in FIGS. 1 and 2, the exterior shelter 20 comprises a front shelter 21 adapted for shading the front windshield 12 of the vehicle, a rear shelter 22 adapted for shading the rear windshield 13 of the vehicle, and the flexible shade 23 for shading the side windows 14 of the vehicle.

Each of the front and rear shelters 21, 22 are formed in a planar structure to place at the outer sides of the front and rear windshields 12, 13 respectively. In other words, the front and rear shelters 21, 22 are overlapped on the outer sides of the front and rear windshields 12, 13 respectively.

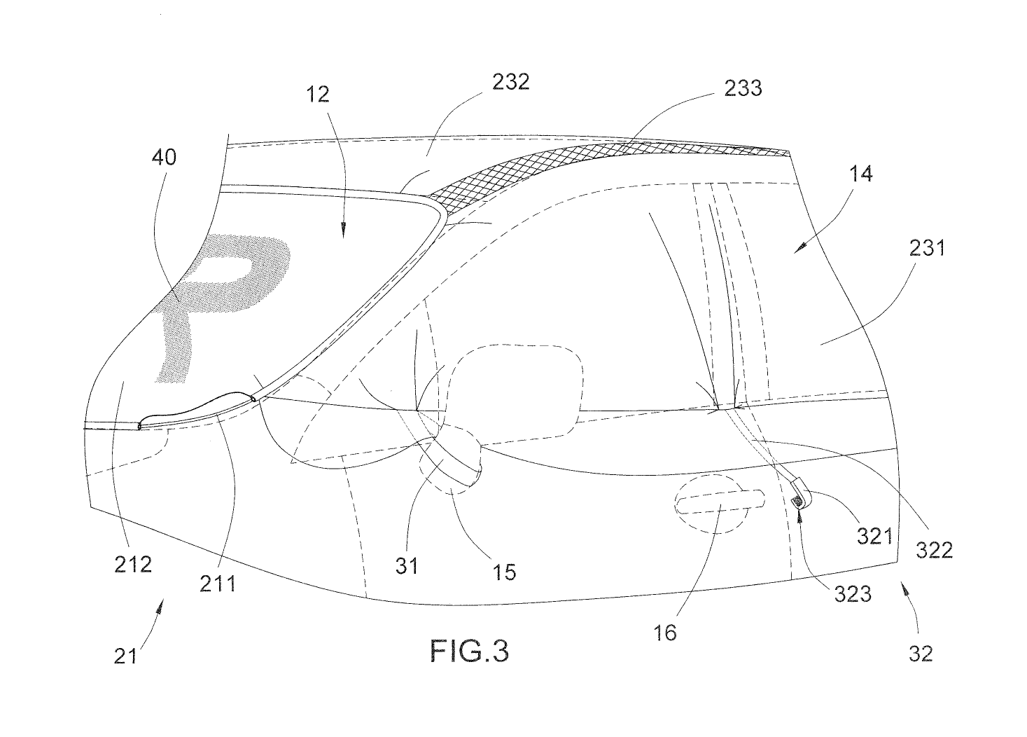

As shown in FIG. 3, the front shelter 21 comprises a front resilient retention frame 211 and a front shading sheet 212 supported by the front resilient retention frame 211 to retain a shape of the front shading sheet 212 in a tension manner. In particular, the front resilient retention frame 211 is formed in a loop structure and is made by an elastic wire bent to form a loop form. The front shading sheet 212 is supported within the front resilient retention frame 211 in a tension manner. Due to the elastic force of the front resilient frame 211, the front resilient retention frame 211 will apply an outward stretching force to maintain the tension of the front shading sheet 212, so as to form the front shelter 21 in a planar structure.

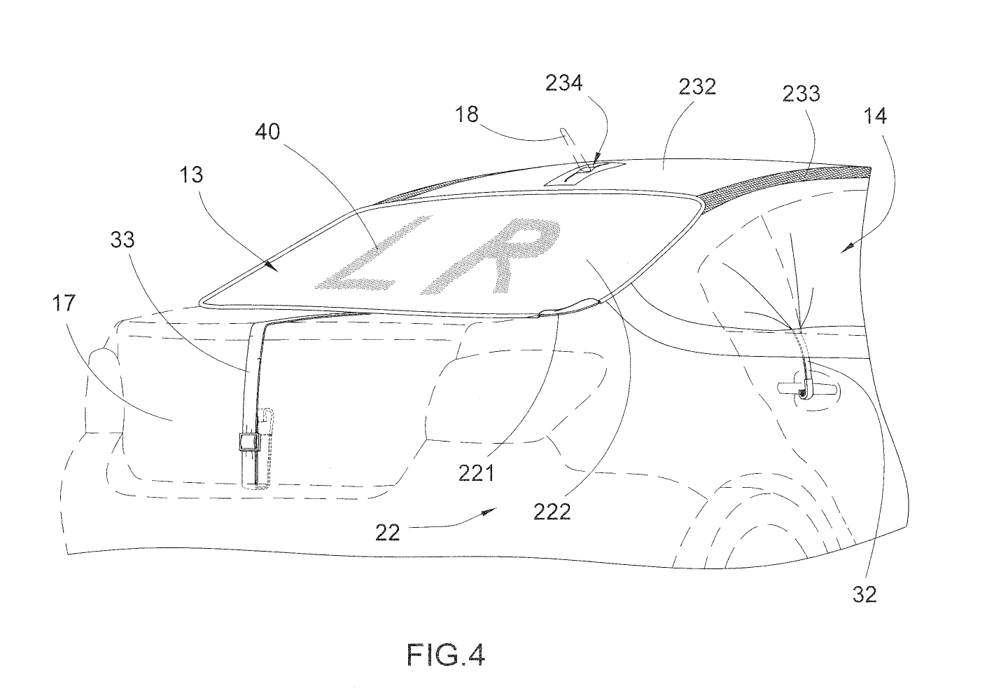

Likewise, the rear shelter 22 comprises a rear resilient retention frame 221 and a rear shading sheet 222 supported by the rear resilient retention frame 211, as shown in FIG. 4, to retain a shape of the rear shading sheet 222 in a tension manner. In particular, the rear resilient retention frame 221 is formed in a loop structure and is made by an elastic wire bent to form a loop form. The rear shading sheet 222 is supported within the rear resilient retention frame 221 in a tension manner. Due to the elastic force of the rear resilient frame 221, the rear resilient retention frame 221 will apply an outward stretching force to maintain the tension of the rear shading sheet 222, so as to form the rear shelter 22 in a planar structure.

Preferably, the shape and size of the front and rear shelters 21, 22 are identical. However, the front and rear shelters 21, 22 can be formed in different sizes matching with the sizes of the front and rear windshields 12, 13 respectively. Furthermore, each of the front and rear shelters 21, 22 has a quadrilateral shape that each of the front and rear resilient retention frames 211, 221 is formed in a quadrilateral shape. It is worth mentioning that two or more front and rear resilient retention frames 211, 221 can be formed at the front and rear shelters 21, 22 respectively. In other words, the front shading sheet 212 can be retained in a tension manner vi the two or more front resilient retention frames 211 while the rear shading sheet 222 can be retained in a tension manner vi the two or more rear resilient retention frames 221.

As shown in FIGS. 1 and 2, the flexible shade 23 is extended between the front and rear shelters 21, 22. The flexible shade 23 comprises two side shading sheets 231 extended between the front and rear shelters 21, 22 for shading the side windows 14 of the vehicle respectively. Accordingly, the side shading sheets 231 are extended from two sides of the front shelter 21 to two sides of the rear shelter 22 to shade at the outer sides of the side windows 14 of the vehicle. It is worth mentioning that the side shading sheets 231 are adapted to entirely cover the side windows 14 of the vehicle which include front and back side windows and quarter glasses.

The flexible shade 23 further comprises a top shading sheet 232 for shading the roof 11 of the vehicle. According to the preferred embodiment, the top shading sheet 232 is longitudinally extended between the front and rear shelters 21, 22 and is transversely extended between the two side shading sheets 231. In other words, the flexible shade 23 will cover the roof 11 and the side windows 14 of the vehicle to block the heat radiation entering into the vehicle through the roof 11 and the side windows 14.

The flexible shade 23 further has a per-formed guiding slit 234 provided on the top shading sheet 232 for a roof component 18, such as a vehicle antenna, of the vehicle passing therethrough when the top shading sheet 232 covers on the roof 11 of the vehicle. Accordingly, the guiding slit 234 is formed at the rear portion of the top shading sheet 232 close to the rear shelter 22. In particular, an elongated opening of the guiding slit 234 is stitched by one or more threads initially. When the top shading sheet 232 covers on the roof 11 of the vehicle, the user is able to determine the location of the roof component 18 with respect to the guiding slit 234, such that the user is able to cut the thread to open up the guiding slit 234 to enable the roof component 18 extended out of the top shading sheet 232 through the guiding slit 232.

According to the preferred embodiment, when the front and rear shelters 21, 22 are placed at the front and rear windshields 12, 13 respectively, the flexible shade 23 is stretched out to cover the roof 11 and the side windows 14 of the vehicle. In other words, once the front and rear shelters 21, 22 are placed in position, the side shading sheets 231 are automatically aligned with and cover to the side windows 14 of the vehicle while the top shading sheet 232 is automatically aligned with and cover on the roof 11 of the vehicle. It is worth mentioning that since the front and rear shelters 21, 22 are formed in a planar structure, a distance between the two side shading sheets 231 will be automatically retained to enhance the mounting operation of the exterior shelter 20. In other words, due to the elastic forces of the front and rear resilient frames 211, 221, the curvature of the flexible sheet 23 will be retained and the shape of the sheltering cavity 201 of the exterior shelter 20 will be retained for sheltering the upper vehicle frame of the vehicle once the front and rear shelters 21, 22 are pulled away from each other.

It is worth mentioning that the front and rear shading sheets 212, 222, the two side shading sheets 231, and the top shading sheet 232 are made of same heat blocking material, such as heat reflection material, for substantially blocking the heat radiation of sunlight to enter into the vehicle. The front and rear shading sheets 212, 222, the two side shading sheets 231, and the top shading sheet 232 are made of waterproof material. In addition, the front and rear shading sheets 212, 222, the two side shading sheets 231, and the top shading sheet 232 are made of opaque material for preventing the interior of the vehicle to be seen when the exterior shelter 20 shades the exterior of the vehicle. In other words, when the exterior shelter 20 covers the window frame of the vehicle, the interior of the vehicle cannot be seen through the exterior shelter 20 so as to completely conceal the interior of the vehicle for protecting privacy.

The flexible shade 23 further has at least an air mesh portion 233 for communicating an interior of the exterior shelter 20 with an exterior thereof, so as to enable the air circulation of the sheltering cavity 201. As shown in FIGS. 1, 3, and 4, the air mesh portion 233 is provided between the top shading sheet 232 and each of the side shading sheets 231. In other words, two air mesh portions 232 are formed at two longitudinal sides of the top shading sheet 232 to link with the side shading sheets 231.

Accordingly, when the vehicle is parked under the sun, hot air may trap in the sheltering cavity 201. The air mesh portion 232 will allow the hot air in the sheltering cavity 201 to release to the exterior of the exterior shelter 20. Furthermore, during the windy day, the wind may blow into the sheltering cavity 201 of the exterior shelter 20. Therefore, the air mesh portion will ensure the wind in the sheltering cavity 201 to escape to the exterior of the exterior shelter 20.

The vehicle sun shelter of the present invention comprises a quick releasable fastener 30 extended from the exterior shelter 20 for releasably fastening the vehicle body of the vehicle in order to provide at least two fastening points for the exterior shelter 20 to retain the exterior shelter 20 in position.

Accordingly, the quick releasable fastener 30 provides different types of fasteners to detachably fasten at different locations of the vehicle body of the vehicle. As shown in FIG. 3, the quick releasable fastener 30 comprises two elastic loops 31 downwardly extended from the side shading sheets 231 for detachably fastening at two side mirror frames 15 of the vehicle respectively. Each of the elastic loops 31 is made of an elongated elastic strap formed in a loop shape by affixing two ends of the elastic strap to the side shading sheet 231. In particular, the elastic loops 31 are affixed to inner sides of the side shading sheets 231, such that when the elastic loops 31 are detachably fastened at the side minor frames 15, the front shelter 21 is pulled to overlap on the front windshield 12 while the front portions of the side shading sheets 231 are pulled downwardly to retain the side shading sheets 231 to cover at the side windows 14 of the vehicle.

As shown in FIGS. 3 and 4, the quick releasable fastener 30 further comprises at least two elastic door handle fasteners 32 downwardly extended from the side shading sheets 231 for detachably fastening at two door handles 16 of the vehicle respectively. Each of the elastic door handle fasteners 32 comprises a handle hook 321 and an elongated elastic strap 322 having an upper end affixed to the inner side of the side shading sheet 231 and a lower end affixed to the handle hook 321, such that when the handle hook 321 is detachably fastened at the door handle 16 of the vehicle, the elastic strap 322 is stretched to pull the side shading sheet 231 downwardly. A cushioning layer 323 is provided at a hooking surface of the handle hook 321 to prevent any scratch of the door handle 16 when the handle hook 321 is fastened thereat.

It is appreciated that there are four elastic door handle fasteners 32 for a four-door vehicle while there are two elastic door handle fasteners 32 for a two-door vehicle. It is worth mentioning that when the elastic loops 31 and the elastic door handle fasteners 32 are detachably fastened at the side mirror frames 15 and the door handles 16 respectively, the flexible shade 23 is substantially and evenly pulled downwardly to retain the top shading sheet 232 to be overlaid on the roof 11 of the vehicle and to ensure the side shading sheets 231 to cover the side windows 14 of the vehicle.

For a full size vehicle, the quick releasable fastener 30 further comprises an elastic trunk fastener 33 downwardly extended from the rear shelter 22 for detachably fastening at a trunk 17 of the vehicle. The elastic trunk fastener 33 comprises a length-adjustable elastic strap extended from an inner side of the rear shelter 22 and a trunk buckle provided at the end of the length-adjustable elastic strap. In order to fasten the elastic trunk fastener 33, the user is able to open up the trunk cover and place the trunk buckle inside the trunk 17. Once the trunk cover is closed, the trunk buckle is locked inside the trunk 17 to stretch out the length-adjustable elastic strap so as to substantially pull the rear shelter 22 to overlap on the rear windshield 13. It is worth mentioning that since different vehicles have different trunk sizes, the length-adjustable elastic strap can be selectively adjusted its length that the trunk buckle can be placed inside the trunk 17 while the length-adjustable elastic strap is tensionally stretched when the trunk buckle is locked inside the trunk 17. It is worth mentioning that once the trunk buckle is locked inside the trunk 17, the vehicle sun shelter of the present invention cannot be completely detached from the vehicle, so as to provide a security means for preventing the vehicle sun shelter from being lost or stolen. It should be appreciated that the trunk buckle can be replaced by the handle hook 321 that the elastic trunk fastener 33 can be detachably fastened to the trunk 17 of the vehicle by hooking the handle hook 321 at the trunk 17.

In order to mount the vehicle sun shelter to the vehicle, the present invention further provides a method of blocking heat radiation of sunlight entering into the vehicle, comprising the following steps.

(1) Place the front shelter 21 at the front windshield 12 of the vehicle and the rear shelter 22 at the rear windshield 13 of the vehicle for shielding and blocking heat radiation entering into the vehicle through the front and rear windshields, 12, 13. Accordingly, since the front and rear shelters 21, 22 are formed in a planar structure, the user is able to simply put the front and rear shelters 21, 22 at the outer sides of the front and rear windshields, 12, 13.

(2) Automatically align the two side shading sheets 231 with the side windows 14 of the vehicle respectively at the time when the front and rear shelters 21, 22 are placed in position for shielding and blocking heat radiation entering into the vehicle through the side windows 14. At the same time, the top shading sheet 232 is automatically aligned with the roof 11 of the vehicle for shielding and blocking heat radiation entering into the vehicle through the roof 11 of the vehicle. Accordingly, due to the elastic forces of the front and rear resilient frames 211, 221, the curvature of the flexible sheet 23 will be retained and the shape of the sheltering cavity 201 of the exterior shelter 20 will be retained. Therefore, once the front and rear shelters 21, 22 are pulled away from each other and are placed at the front and rear windshields, 12, 13, the roof 11 and the side windows 14 of the vehicle will be automatically shielded by the top shading sheet 232 and the side shading sheets 231.

(3) Detachably fasten the quick releasable fastener 30 to the vehicle body of the vehicle to retain the front and rear shelters and the side shading sheets in position. Accordingly, once the upper vehicle frame of the vehicle is shielded by the exterior shelter 20, the user is able to simply fasten the two elastic loops 31 at two side mirror frames 15 of the vehicle respectively and fasten the elastic door handle fasteners 32 at the door handles 16 of the vehicle respectively. Optionally, the user is able to fasten the elastic trunk fastener 33 at the trunk 17 of the vehicle for further securely the attachment between the exterior shelter 20 and the vehicle.

It is worth mentioning that the exterior shelter 20 only shields the upper vehicle frame of the vehicle but not the entire vehicle for blocking the heat entering into the vehicle. The user does not have to mount the exterior shelter 20 to cover the hood or the door of the vehicle. The entire mounting operation is simple and easy that only one person can complete the operation in one minute.

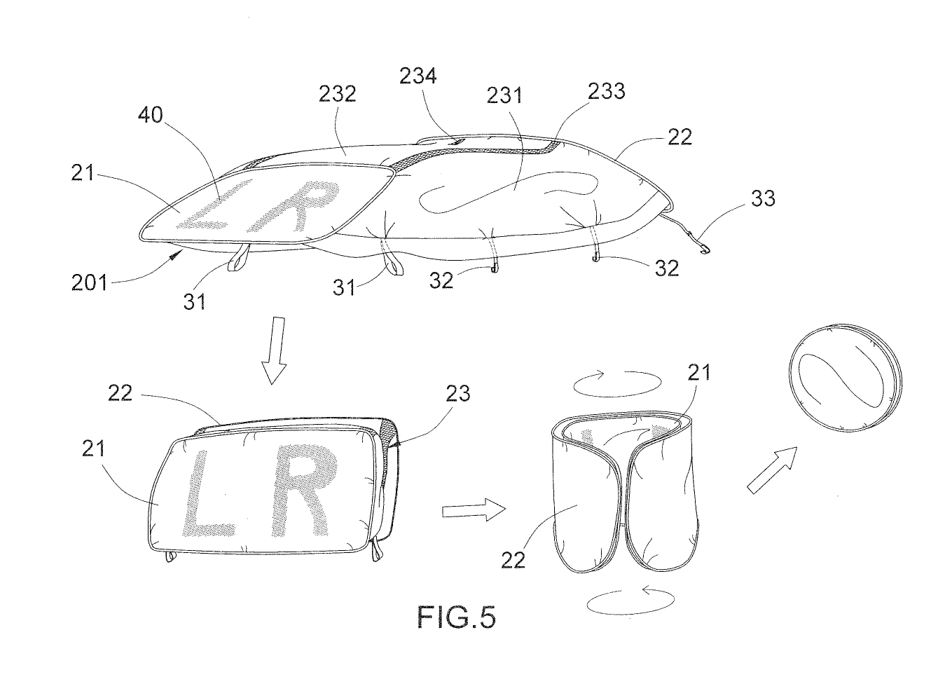

In order to fold up the vehicle sun shelter, as shown in FIG. 5, the user is able to overlap the front and rear shelters 21, 22 with each other in order to receive and sandwich the flexible shade 23 between the front and rear shelters 21, 22. Then, the user is able to fold and twist the overlapped front and rear shelters 21, 22 to form a compact unit for storage.

It is worth mentioning that for individual use, the user is able to place the folded unit in the vehicle such that after the vehicle is parked, the user is able to unfold the unit by the elastic forces of the front and rear resilient frames 211, 221 and is able to mount the vehicle sun shelter to the vehicle conveniently. Accordingly, the interior temperature of the vehicle can drop 40° F. when the vehicle is shielded by the vehicle sun shelter comparing with the vehicle without the vehicle sun shelter under the same condition.

For a vehicle dealer, the operator is able to shield all the new vehicles in the parking lot by the vehicle sun shelters of the present invention. In addition, the vehicle sun shelter can also form an advertising media by providing a logo or advertising sign on the exterior shelter 20. For example, different logos 40 are provided at the front and rear shelters 21, 22, the side shading sheets 231 and/or the top shading sheet 232. Preferably, the logo 40 is used for providing a fluorescent effect that the logo 40 with fluorescent material is printed on the exterior shelter 20. Likewise, company name can be printed on the exterior shelter 20. In other words, the vehicle sun shelters of the present invention can provide multiple functions of blocking the heat entering into the vehicle and providing an advertising media at the same time.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A vehicle sun shelter for a vehicle, comprising:
an exterior shelter for shading an exterior of the vehicle to block heat radiation of sunlight entering into the vehicle, wherein said exterior shelter comprises a front shelter adapted for shading a front windshield of the vehicle, a rear shelter adapted for shading a rear windshield of the vehicle, and a flexible shade which comprises two side shading sheets extended between said front and rear shelters for shading side windows of the vehicle respectively; and
a quick releasable fastener extended from said exterior shelter for releasably fastening a vehicle body of the vehicle in order to provide at least two fastening points for said exterior shelter to retain said exterior shelter in position.

2. The vehicle sun shelter, as recited in claim 1, wherein said front shelter comprises a front resilient retention frame and a front shading sheet supported by said front resilient retention frame to retain a shape of said front shading sheet in a tension manner for shading the front windshield of the vehicle, wherein said rear shelter comprises a rear resilient retention frame and a rear shading sheet supported by said rear resilient retention frame to retain a shape of said rear shading sheet in a tension manner for shading the rear windshield of the vehicle.

3. The vehicle sun shelter, as recited in claim 2, wherein said front and rear shelters are overlapped with each other to receive said flexible shade therebetween, wherein said front and rear resilient retention frames are twisted to fold up said exterior shelter.

4. The vehicle sun shelter, as recited in claim 1, wherein said flexible shade further comprises a top shading sheet extended between said front and rear shelters and extended between said two side shading sheets for shading a roof of the vehicle.

5. The vehicle sun shelter, as recited in claim 3, wherein said flexible shade further comprises a top shading sheet extended between said front and rear shelters and extended between said two side shading sheets for shading a roof of the vehicle.

6. The vehicle sun shelter, as recited in claim 5, wherein said flexible shade further has at least an air mesh portion for communicating an interior of said exterior shelter with an exterior thereof.

7. The vehicle sun shelter, as recited in claim 6, wherein said air mesh portion is provided between said top shading sheet and each of said side shading sheets.

8. The vehicle sun shelter, as recited in claim 1, wherein said quick releasable fastener comprises two elastic loops downwardly extended from said side shading sheets for detachably fastening at two side mirror frames of the vehicle respectively.

9. The vehicle sun shelter, as recited in claim 7, wherein said quick releasable fastener comprises two elastic loops downwardly extended from said side shading sheets for detachably fastening at two side mirror frames of the vehicle respectively.

10. The vehicle sun shelter, as recited in claim 8, wherein said quick releasable fastener further comprises at least two elastic door handle fasteners downwardly extended from said side shading sheets for detachably fastening at two door handles of the vehicle respectively.

11. The vehicle sun shelter, as recited in claim 9, wherein said quick releasable fastener further comprises at least two elastic door handle fasteners downwardly extended from said side shading sheets for detachably fastening at two door handles of the vehicle respectively.

12. The vehicle sun shelter, as recited in claim 10, wherein said quick releasable fastener further comprises an elastic trunk fastener downwardly extended from said rear shelter for detachably fastening at a trunk of the vehicle.

13. The vehicle sun shelter, as recited in claim 11, wherein said quick releasable fastener further comprises an elastic trunk fastener downwardly extended from said rear shelter for detachably fastening at a trunk of the vehicle.

14. The vehicle sun shelter, as recited in claim 13, wherein said exterior shelter is made of opaque material for preventing an interior of the vehicle to be seen when said exterior shelter shades the exterior of the vehicle.

15. A method of blocking heat radiation of sunlight entering into the vehicle, comprising the steps of:
(a) placing a front shelter at a front windshield of the vehicle and a rear shelter at a rear windshield of the vehicle for blocking heat radiation entering into the vehicle through the front and rear windshields;
(b) aligning two side shading sheets, which are extended between said front and rear shelters, with side windows of the vehicle respectively at the time when said front and rear shelters are placed in position for blocking heat radiation entering into the vehicle through the side windows; and
(c) detachably fastening a quick releasable fastener to a vehicle body of the vehicle to provide at least two fastening points to retain said front and rear shelters and said side shading sheets in position.

16. The method, as recited in claim 15, further comprising the folding steps of overlapping said front and rear shelters with each other to receive said side shading sheets therebetween and twisting said front and rear shelters to fold into a compact size.

17. The method, as recited in claim 16, wherein the step (b) further comprises a step of aligning a top shading sheet with a roof of the vehicle at the time when said front and rear shelters are placed in position for blocking heat radiation entering into the vehicle through the roof, wherein said top shading sheet extended between said front and rear shelters and extended between said two side shading sheets.

18. The method, as recited in claim 16, wherein the step (c) further comprises a step of detachably fastening two elastic loops at two side mirror frames of the vehicle respectively, wherein said two elastic loops are downwardly extended from said side shading sheets respectively.

19. The method, as recited in claim 18, wherein the step (c) further comprises a step of detachably fastening at least two elastic door handle fasteners at two door handles of the vehicle respectively, wherein said two elastic door handle fasteners are downwardly extended from said side shading sheets respectively.

20. The method, as recited in claim 18, wherein the step (c) further comprises a step of detachably fastening an elastic trunk fastener at a trunk of the vehicle, wherein said elastic trunk fastener is downwardly extended from said rear shelter.
